(19) United States
(12) Patent Application Publication
(10) Pub. No.: US 2015/0240793 A1
(43) Pub. Date: Aug. 27, 2015

(54) TEMPERATURE CONTROL SYSTEM FOR SHAPE-MEMORY ALLOY

(71) Applicant: THE BOEING COMPANY, Chicago, IL (US)

(72) Inventors: Morteza Safai, Newcastle, WA (US); Kimberly D. Meredith, Newcastle, WA (US); Sahrudine Apdalhaliem, Seattle, WA (US); Moushumi Shome, Kent, WA (US); Frederick T. Calkins, Renton, WA (US)

(73) Assignee: THE BOEING COMPANY, Chicago, IL (US)

(21) Appl. No.: 14/186,915

(22) Filed: Feb. 21, 2014

(51) Int. Cl. F03G 7/06

(52) U.S. Cl. CPC F03G 7/065

(57) ABSTRACT

Described herein is an apparatus for controlling an actuator made from a shape-memory alloy includes a first layer made from a thermally conductive material and a second layer. The second layer is made from a thermally conductive material. The apparatus also includes at least one thermoelectric heater positioned between the first and second layers. Additionally, the apparatus includes at least one thermoelectric cooler positioned between the first and second layers.

### FIELD

This disclosure relates generally to shape-memory alloys, and more particularly to controlling the temperature of actuators made from shape-memory alloys.

### BACKGROUND

Some high-tech industries have started incorporating shape-memory alloys into various products. Today, many complex structures, such as aircraft, spacecraft, automobiles, and the like, are made from shape-memory alloys. Shape-memory alloys are special metallic materials that are capable of returning to a previously defined shape (e.g., original shape) after being heated to deformation (e.g., a deformed state).

Generally, a shape-memory alloy is in a martensite low temperature phase with a cubic crystal structure, which begins to transform into an austenite high temperature phase with a monoclinic crystal upon reaching a first austenite threshold temperature. The transformation from the martensite low temperature phase to the austenite high temperature phase is completed upon reaching a second austenite threshold temperature higher than the first austenite threshold temperature. From the austenite high temperature phase, the transformation to the martensite low temperature phase is initiated and completed after the temperature of the shape-memory alloy is cooled below first and second martensite threshold temperatures, respectively. As the shape-memory alloy transforms between the austenite high temperature phase and martensite low temperature phase, the alloy physically deforms between an original shape and a deformed shape.

The unique characteristics (e.g., pseudoelasticity and shape memory effect) of shape-memory alloys promote their use in different applications. However, due to relatively slow transformations from the deformed shape back to the original shape, shape-memory alloys remain impractical for many applications, particularly where rapid response times are useful.

### SUMMARY

The subject matter of the present application has been developed in response to the present state of the art, and in particular, in response to the shortcomings of shape-memory alloys for use with various systems, such as aircraft, that have not yet been fully solved by currently available techniques. Accordingly, the subject matter of the present application has been developed to provide an apparatus, system, and method that overcome at least some of the above-discussed shortcomings of prior art techniques. More particularly, described herein is a system that rapidly controls the temperature modulations and actuation of a shape-memory alloy. In certain implementations, such as system facilitates the use of shape-memory alloys as an actuator in systems where precise and responsive control of actuated components is useful.

According to one embodiment, an apparatus for controlling an actuator made from a shape-memory alloy includes a first layer made from a thermally conductive material and a second layer, which can be spaced apart from the first layer. The second layer is made from a thermally conductive material. The apparatus also includes at least one thermoelectric heater positioned between the first and second layers. Additionally, the apparatus includes at least one thermoelectric cooler positioned between the first and second layers.

In some implementations, the apparatus further includes an electrical power source that selectively transmits electrical power to the thermoelectric heater and thermoelectric cooler. Electrical power can be asynchronously transmitted to the thermoelectric heater and thermoelectric cooler.

According to certain implementations, the apparatus also includes first electrical connections that are positioned between the first layer and the thermoelectric heater and cooler, and second electrical connections that are positioned between the second layer and the thermoelectric heater and cooler. The first and second electrical connections can be electrically coupled to an electrical power source.

In certain implementations of the apparatus, each of the thermoelectric heater and cooler comprises a P-element made from a P-type semiconductor material and an N-element made from an N-type semiconductor material. The P-element and N-element of the thermoelectric heater and cooler can have first and second ends opposing each other. The first ends are proximate the first layer and the second end is proximate the second layer. The first ends of the P-element and N-element of the thermoelectric heater are electrically coupled and the second ends of the P-element and N-element of the thermoelectric heater are electrically isolated from each other. The first ends of the P-element and N-element of the thermoelectric cooler are electrically isolated from each other and the second ends of the P-element and N-element of the thermoelectric cooler are electrically coupled to each other. The apparatus may also include a first electrical power source that has a negative terminal electrically coupled to the second end of the N-element of the thermoelectric heater and a positive terminal electrically coupled to the second end of the P-element of the thermoelectric heater. Additionally, the apparatus can have a second electrical power source that has a negative terminal electrically coupled to the first end of the N-element of the thermoelectric cooler and a positive terminal electrically coupled to the first end of the P-element of the thermoelectric cooler.

According to some implementations, the apparatus includes a plurality of thermoelectric heaters positioned between the first and second layers, and a plurality of thermoelectric coolers positioned between the first and second layers. The plurality of thermoelectric heaters and/or the plurality of thermoelectric coolers can be evenly distributed between the first and second layers. Alternatively, the plurality of thermoelectric heaters and/or the plurality of thermoelectric coolers can be unevenly distributed between the first and second layers. In certain implementations, each of the plurality of thermoelectric heaters is independently controllable, and each of the plurality of thermoelectric coolers is independently controllable. The plurality of thermoelectric heaters and coolers can be arranged side-by-side in an alternating pattern.

In certain implementations, the apparatus includes a control module that is configured to selectively activate the thermoelectric heater to actuate the actuator into an engaged position, and selectively activate the thermoelectric cooler to actuate the actuator into a disengaged position. The apparatus can be flexible in some implementations. In yet some implementations, the apparatus has a generally hollow cylindrical shape.

According to another embodiment, an apparatus includes an adjustable element, which can be an aerodynamic surface in some implementations. The apparatus further includes an actuator that is coupled to the adjustable aerodynamic surface. The actuator is made from a shape-memory alloy. Furthermore, modulating a temperature of the shape-memory alloy actuates the actuator. The apparatus also includes a temperature modulation device in heat transfer communication with the actuator. The temperature modulation device includes an array of p-type semiconductors and n-type semiconductors.

In some implementations of the apparatus, the temperature modulation device includes a plurality of heaters and a plurality of coolers. Each heater includes a pair of p-type and n-type semiconductors in a first orientation and each cooler includes a pair of p-type and n-type semiconductors in a second orientation. The plurality of heaters and plurality of coolers can be separately controllable to respectively heat and cool the actuator. According to certain implementations, each of the plurality of heaters is separately controllable relative to other heaters, and each of the plurality of coolers is separately controllable relative to other coolers. The apparatus can be any of various vehicles or structures, but in one implementation, the apparatus is an aircraft.

According to yet another embodiment, a method for controlling actuation of an actuator made from a shape-memory alloy includes transmitting an electrical current through a first P-N element set to heat the actuator, and transmitting an electrical current through a second P-N element set to cool the actuator.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view of an aircraft according to one embodiment;

FIG. 2 is a detailed perspective view of a horizontal stabilizer portion of the aircraft of FIG. 1 according to one embodiment;

FIG. 3 is a cross-sectional end view at a first location of an actuator system in a heating mode according to one embodiment;

FIG. 4 is a cross-sectional end view of an actuator system at a second location in a cooling mode according to one embodiment;

FIG. 5 is a perspective view of a temperature control system for an actuator system according to yet another embodiment;

FIG. 6 is a side view of a temperature control system in a heating mode according to one embodiment;

FIG. 7 is a side view of the temperature control system of FIG. 6 in a cooling mode according to one embodiment; and

FIG. 8 is a schematic flow diagram of a method for controlling actuation of an actuator made from a shape-memory alloy according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

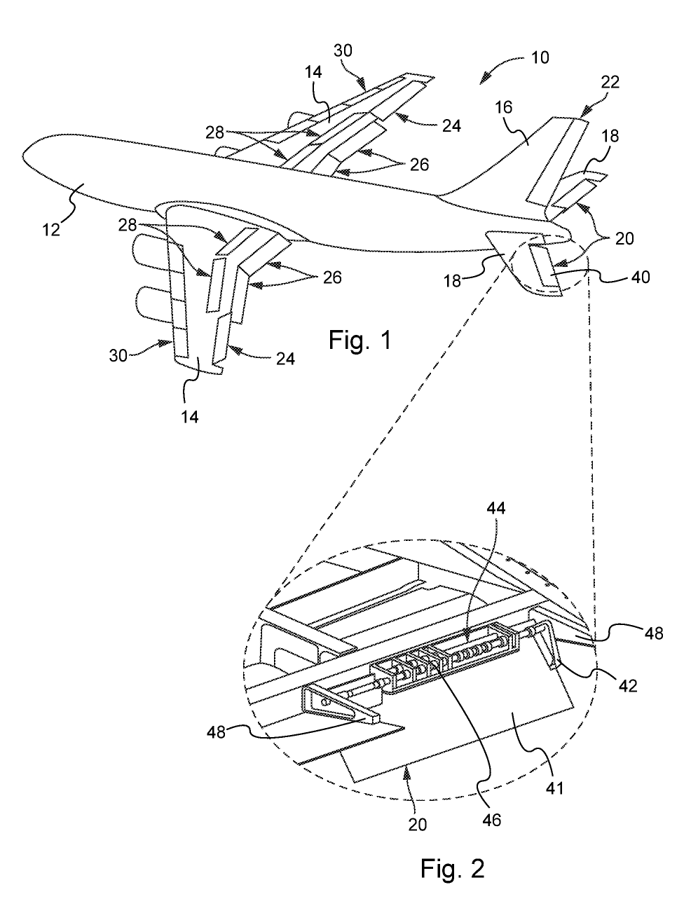

Referring to FIG. 1, one embodiment of an aircraft 10 is shown. The aircraft 10 can be any of various types of aircraft, such as commercial aircraft used for the transportation of passengers, military aircraft for military operations, personal aircraft, and the like. Moreover, although an aircraft is depicted in the illustrated embodiments, in other embodiments, another structure, such as a vehicle (e.g., helicopter, boat, spacecraft, automobile, etc.) or non-mobile complex structure (e.g., building, bridge, machinery, etc.), with any of various adjustable elements, can be used.

The depicted aircraft 10 includes a body 12 (e.g., fuselage), a pair of wings 14 coupled to and extending from the body 12, a vertical stabilizer 16 coupled to the body, and a pair of horizontal stabilizers 18 coupled to the body and/or the vertical stabilizer. The aircraft 10 can be any of various types of aircraft, such as a passenger airplane, a fighter jet, a helicopter, spacecraft, and the like. As depicted, the aircraft 10 represents a passenger airplane.

The aircraft 10 further includes a plurality of adjustable elements, which can be adjustable aerodynamic surfaces that are adjustable to change the characteristics of air flow over, around, and trailing the surfaces. For example, each wing 14 includes an aileron 24, flaps 26, spoilers 28, and slats 30. Additionally, the vertical stabilizer 16 includes a rudder 22, and each horizontal stabilizer 18 includes an elevator 20. For responsive control of the flight of the aircraft 10, the relative position of the adjustable aerodynamic surfaces of the aircraft, such as those shown in FIG. 1, should be capable of rapid and precise adjustment. Accordingly, the systems (e.g., actuator systems) for adjusting the position of adjustable aerodynamic surfaces are designed to promote rapid and precise adjustment of the surfaces. Additionally, the actuator systems for adjusting the position of adjustable aerodynamic surfaces are desirably lightweight, reliable, and efficient. Although some current mechanical, hydraulic, and pneumatic controlled actuator systems may provide rapid and precise adjustment of the surfaces, such systems are generally heavy and inefficient. In contrast, although some conventional actuator systems that use shape-memory alloy actuators may be lightweight and efficient, such conventional systems would provide only slow and imprecise control of adjustable aerodynamic surfaces if implemented in an aircraft, or other vehicle or structure.

According to certain embodiments, the actuator system of the present disclosure includes an actuator made from a shape-memory alloy and a temperature control system. Moreover, in some embodiments, the actuator system is lightweight, reliable, and efficient, and further provides rapid and precise adjustment of an adjustable component, such as an aerodynamic surface of an aircraft. Referring to FIG. 2, the elevator 20 of the horizontal stabilizer 18 of the aircraft 10 is actuated via an actuator system 44. The elevator 20 includes an upper panel 40 and a lower panel 41 that are joined together at a trailing edge. The upper panel 40 and lower panel 41 define upper and lower surfaces, respectively, of the elevator 20. For convenience in showing the actuator system 44, which is positioned proximate a leading edge of the elevator 20, an upper surface of the stabilizer 18 and the upper panel 40 is removed in FIG. 2. The upper and lower panels 40, 41 are supported in proper orientation relative to each other by a pair of brackets 42. The brackets 42 are hingedly coupled to structural components 48 of the horizontal stabilizer 18 such that the brackets and elevator 20 are pivotable relative to the fixed surfaces of the horizontal stabilizer. The horizontal stabilizer 18 includes a pivot rod 46 that spans from the structural component 48 to the opposing structural component 48 of the horizontal stabilizer to rotatably support the elevator 20 relative to the structural components and fixed surfaces of the horizontal stabilizer. In one implementation, the pivot rod 46 includes one or more gears that engage one or more other gears driven by the actuator system 44.

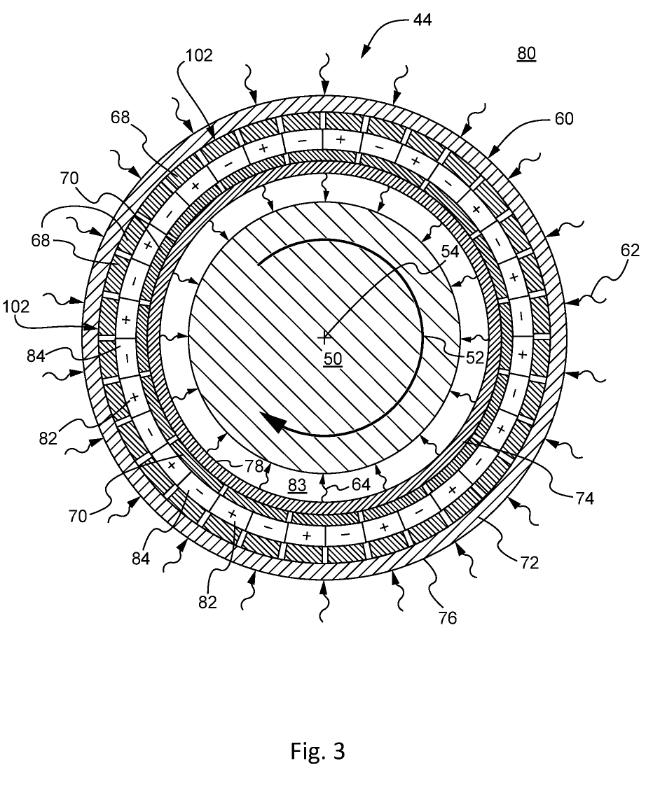

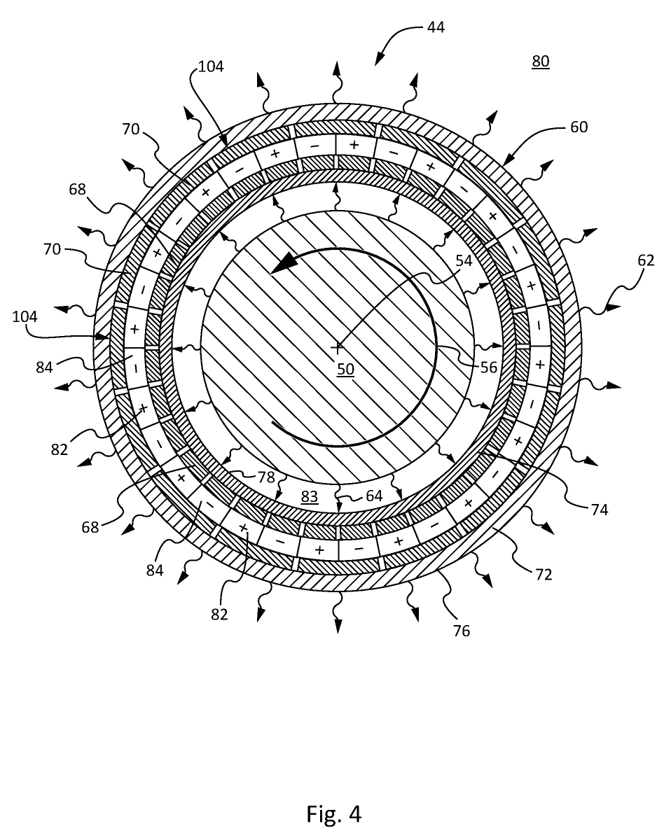

Generally, the actuator system 44 is configured to rotate the pivot rod 46, which in turn rotates the brackets 42 and the elevator 20. Accordingly, the actuator system 44 is actuated or controlled to maintain the elevator 20 in, or move the elevator into, a desired position or orientation relative to the horizontal stabilizer 18. Referring to FIGS. 3 and 4, and according to one embodiment, the actuator system 44 includes an actuator 50 and a temperature control system 60. The actuator 50 is made from a shape-memory alloy and deforms between an original shape and a deformed shape based on the temperature of the actuator. The temperature control system 60 controls the temperature, and thus the deformation of, the actuator 50. As defined previously, shape-memory alloys are special metallic materials that are capable of returning to a previously defined shape (e.g., original shape) after being heated to deformation (e.g., a deformed state). In some embodiments, the shape-memory alloy of the actuator 50 is at least one of nickel-titanium alloys and copper-base alloys, among others. The composition of the shape-memory alloy can be selected to provide a desired range of deformation as well as desired upper and lower threshold temperatures associated with respective phase changes of the alloy.

The actuator 50 can have any of various shapes and sizes, and can deform in any of various manners into different shapes and sizes. In the illustrated embodiment, the actuator 50 is a generally cylindrical-shaped rod configured to rotationally deform about a central axis 54 of the rod as the temperature of the rod fluctuates. More specifically, in one implementation, as the temperature of the actuator 50 increases beyond the upper threshold temperature, the rod rotates or torques about the central axis 54 in a first direction 52 (see, e.g., FIG. 3). In contrast, as the temperature of the actuator 50 decreases below the lower threshold temperature, the rod rotates or torques about the central axis 54 in a second direction 56 that is opposite the first direction 52 (see, e.g., FIG. 4). The actuator 50 is co-movably coupled to a drive mechanism, such as a drive gear, that rotates as the actuator rotates. Accordingly, the internal rotation or torque of the actuator 50 as the actuator deforms due to temperature modulations correspondingly drives a drive mechanism. The drive mechanism of the actuator 50 is engaged with a mating feature, such as a driven gear, of an adjustable component. As the actuator 50 deforms, engagement between the drive mechanism of the actuator and the mating feature of adjustable component moves the adjustable component. In the illustrated embodiment, as the rod of the actuator 50 rotates, the drive mechanism rotates the pivot rod 46 and the elevator 20 rotates about the pivot rod.

The temperature control system 60 is selectively operated to apply heat or thermal energy to the actuator 50 in a heat mode and remove heat from the actuator in a cool mode. Generally, in the heat mode, the transmission of energy to the actuator 50 is facilitated by the electrically-induced transfer of subatomic particles or charge carriers in a first direction between two thermally-conductive layers. In contrast, in the cool mode, the transmission of energy from the actuator 50 is facilitated by the electrically-induced transfer of subatomic particles or charge carriers in a second direction between the two thermally-conductive layers.

In the illustrated embodiment, the thermally-conductive layers include an outer layer 72 and an inner layer 74. The outer and inner layers 72, 74 are spaced-apart with the inner layer being positioned between the outer layer and the actuator 50. In this manner, the outer layer 72 is positioned further away from the actuator 50 than the inner layer 74. Accordingly, the outer layer 72 can be considered a distal or radially outward layer, and the inner layer 74 can be considered a proximal or radially inward layer. The outer and inner layers 72, 74 are made from a thermally conductive material. In one implementation, the outer and inner layers 72, 74 are made from thermally conductive and electrically nonconductive (e.g., electrically insulating) materials, such as ceramic, epoxies, and the like. The outer and inner layers 72, 74 can be made from the same or different materials. Additionally, the outer and inner layers 72, 74 can be made from a flexible or rigid material. Further, the outer and inner layers 72, 74 can have any of various shapes and sizes. For example, the outer and inner layers 72, 74 may have any of various geometries or number of contact points with the actuator 50 to facilitate thermal transfer into or out from the actuator. In one implementation, one or both of the outer and inner layers 72, 74 may have known thermal management geometries or features, such as fins, to facilitate heat transfer.

Positioned between the outer and inner layers 72, 74 are at least one thermoelectric heater 102 (see, e.g., FIG. 3) and at least one thermoelectric cooler 104 (see, e.g., FIG. 4). In the illustrated embodiment, a plurality of thermoelectric heaters 102 and coolers 104 are positioned between the outer and inner layers 72, 74. The cross-section of FIG. 3 is taken across a first segment of the actuator system 44 to better show the configuration of the thermoelectric heaters 102, and the cross-section of FIG. 4 is taken across a second segment of the actuator system to better show the configuration of the thermoelectric coolers 104. Furthermore, although the thermoelectric heaters 102 are shown positioned directly adjacent each other circumferentially about the temperature control system 60, and the thermoelectric coolers 104 are shown positioned directly adjacent each other circumferentially about the temperature control system, in some embodiments, the heaters and coolers are staggered or alternate relative to each other (e.g., a heater is positioned between two coolers, and vice versa).

Each thermoelectric heater 102 and cooler 104 includes a P-element 82 and an N-element 84. The P-element 82 and N-element 84 form a P-N pair. In some implementations, each thermoelectric heater 102 and cooler 104 can include more than one P-element 82 and/or more than one N-element 84. Each P-element 82 and N-element 84 can have any of various shapes having any of various cross-sectional shapes. In the illustrated embodiment, the P-element 82 and N-element 84 are generally box-shaped with rectangular-shaped cross-sections. The P-elements 82 are made from a P-type semiconductor material (e.g., a semiconductor material, such as silicon, doped with a P-type material, such as boron). Similarly, the N-elements 84 are made from an N-type semiconductor material (e.g., a semiconductor material, such as silicon, doped with an N-type material, such as phosphorus). It is recognized that any of various semiconductor materials doped with any of various P-type and N-type materials can be used to make the P-elements 82 and N-elements 84, respectively, such as bismuth telluride, lead telluride, silicon germanium, and the like.

Referring to FIGS. 3 and 4, the P-element 82 and N-element 84 of each thermoelectric heater 102 and cooler 104 are electrically coupled to electrical connections or terminals 68, 70, and an electrical power source, to form an electrical circuit. For example, as shown, the P-element 82 and N-element 84 of each heater 102 and cooler 104 is separately electrically coupled to a respective terminal 68 at first ends. One of the terminals 68 for each heater 102 and cooler 104 is electrically coupled to a positive line of the electrical power source, and the other of the terminals 68 is coupled to the negative line of the electrical power source. In one specific implementation, the positive and negative lines of the electrical power source are respectively coupled to the P-element 82 and N-element 84. The second ends of the P-element 82 and N-element 84 are electrically coupled together by a bridge electrical terminal 70 that extends between the second ends. In this manner, the P-element 82 and N-element 84 of each heater 102 and cooler 104 form a closed electrical circuit with an electrical power source.

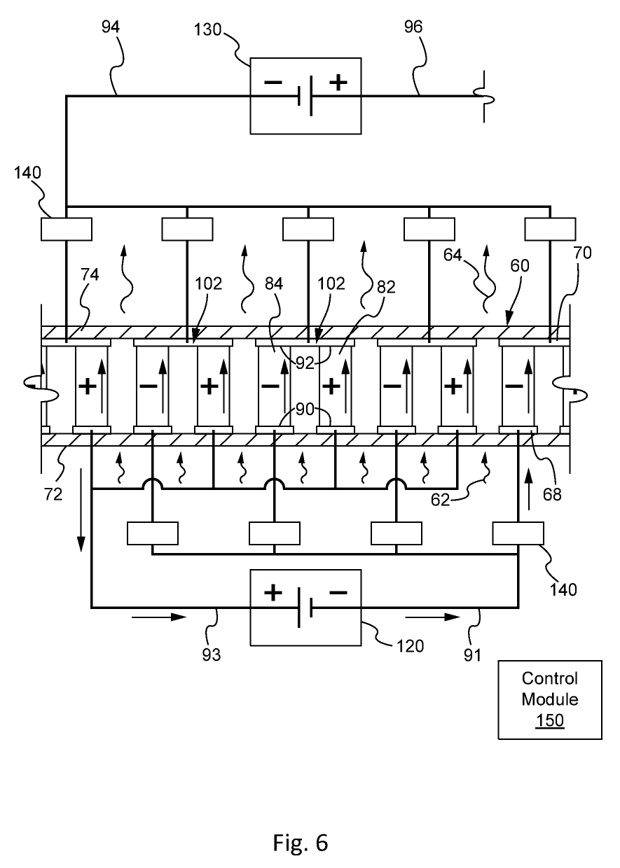

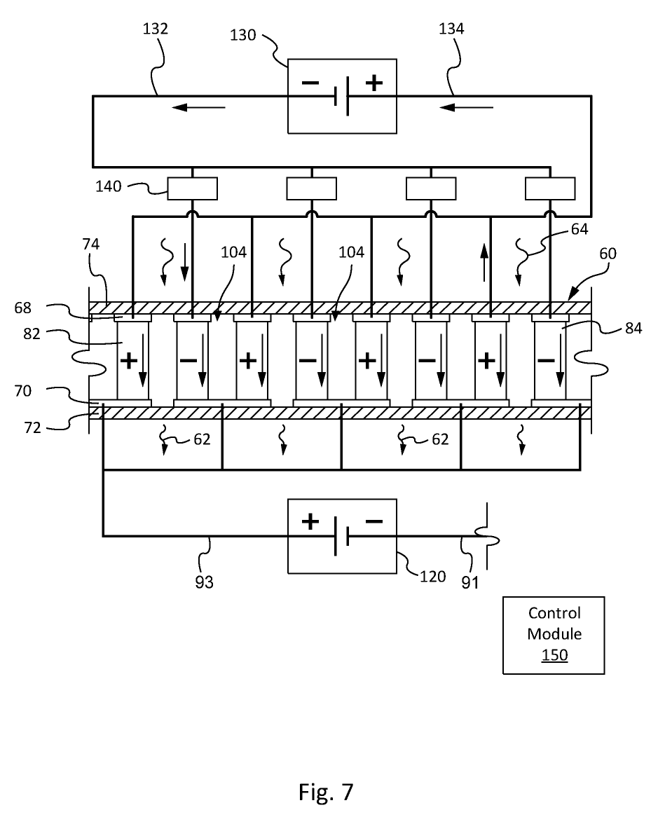

As shown in more detail in FIGS. 6 and 7, in each closed circuit, electrical current passes from a negative line of the power source (e.g., one of power sources, 120, 130) into a first terminal 68 coupled to a first end 90 of the N-element 84. From the N-element 84, electrical current passes into and through the bridge electrical terminal 70 extending between the second ends 92 of the N-element 84 and P-element 82. From the bridge electrical terminal 70, electrical current passes into and through the P-element 82 and into a second terminal 68 coupled to a first end 90 of the P-element 82. From the second terminal 68, the electrical current passes into and through a positive line of the power source to complete the circuit. In some implementations, the electrical power source (e.g., power sources 120, 130) can be controllable to open and close the circuit as desired.

When the electrical circuit of each heater 102 and cooler 104 is closed, the electrical current passing through the N-element 84 and P-element 82 causes electrons in the N-element 84 to flow from the first end 90 to the second end 92 (e.g., from the terminal 68 to the bridge electrical terminal 70, as indicated by directional arrows in FIGS. 6 and 7. The electrical current passing through the P-element 82 causes positive elements or holes also too flow from the first end 90 to the second end 92 of the P-element. The unidirectional flow of electrons (e.g., negative elements) and positive elements through the N-element 84 and P-element 82, respectively, induces a flow of thermal energy in the same direction. The flow of thermal energy creates a temperature gradient between the electrical terminals 68, 70, with the electrical terminals 68 being adjacent a cool side and the electrical terminal 70 being adjacent a hot side. In other words, each heater 102 and cooler 104 transfers heat from a cool side to a hot side via heat transfer induced by the flow of electricity through the N-element 84 and P-element 82.

To facilitate heating and cooling of the actuator 50, the heaters 102 are oriented in a first orientation relative to the actuator 50, and the coolers 104 are oriented in a second orientation relative to the actuator. The first orientation is effectively the opposite the second orientation such that coolers 104 are flipped 180-degrees relative to the heaters 102.

Referring to FIG. 3, during a heat mode, the heaters 102 are activated to transfer heat from surroundings 80 external to the temperature control system 60, as indicated by directional arrows 62, through the heaters, and into the actuator 50, as indicated by directional arrows 64. In the illustrated embodiments, the heaters 102 are positioned between the outer and inner layers 72, 74 such that heat passes from the outer layer to the inner layer before being transferred to the actuator 50. Accordingly, the outer layer 72 has a colder temperature and thus acts as a cold layer or cold plate during heat mode, and the inner layer 74 has a hotter temperature and thus acts as a hot layer or hot plate during heat mode. In some implementations, the temperature control system 60 is configured to place the inner layer 74 in contact with the actuator 50 to facilitate the quick and efficient transfer of heat from the inner layer to the actuator. However, in other implementations, the temperature control system 60 is configured such that the inner layer 74 is spaced apart from the actuator 50 with a space 83 defined between the inner layer and the actuator. In such implementations, heat from the inner layer 74 is transferred to the actuator 50 via the space 83. As the temperature of the actuator 50 increases due to the transfer of heat 64 to the actuator, the shape-memory alloy of the actuator deforms (e.g., rotates in the first direction 52) to actuate or move an actuated component in a first manner (e.g., into a first position).

Referring now to FIG. 4, during a cool mode, the coolers 104 are activated to transfer heat 62, 64 from the actuator 50, through the coolers, and into the surroundings 80. Because the coolers 104 transfer heat in a direction opposite the heaters 102, the inner layer 74 has a colder temperature and thus acts as a cold layer during cool mode, and the outer layer 72 has a hotter temperature and thus acts as a hot layer during cool mode. Accordingly, the outer and inner layers 72, 74 switch from cold and hot layers during the heat mode to hot and cold layers during the cool mode. Accordingly, electrical power is non-concurrently or asynchronously transferred to the heaters and coolers. As described above, in some implementations, the inner layer 74 is in contact with the actuator 50, which can increase the efficiency and speed at which heat 64 is transferred from the actuator. Alternatively, heat 64 can be transferred from the actuator 50 via a space 83 defined between the actuator 50 and the inner layer 74. As the temperature of the actuator 50 decreases due to the transfer of heat 64 away from the actuator 50, the shape-memory alloy of the actuator deforms (e.g., rotates in the second direction 56) to actuate or move an actuated component in a second manner (e.g., into a second position).

Based on the foregoing, the temperature control system 60 can be operated in a heat mode to heat and actuate the actuator 50 in a first manner, and operated in a cool mode to cool and actuate the actuator in a second manner. According to one implementation, the temperature control system 60 operates in the heat mode to actuate the actuator 50 and move a component from an original position into an actuated position, and operates in the cool mode to actuate the actuator and move the component back to the original or some intermediate position. As opposed to conventional temperature control systems that may have active heating to activate a shape-memory alloy actuator, but rely on passive cooling to deactivate the actuator, the temperature control system 60 provides both active heating and cooling functionality to not only quickly and efficiently heat a shape-memory alloy actuator, but quickly and efficiently cool the actuator. Also, in some implementations, the active heating and cooling of the temperature control system 60 can be used to quickly and efficiently control (e.g., maintain) the temperature of the actuator 50 to compensate for external temperature fluctuations, such as those occurring during flight. Such dual-control functionality results in more precise and responsive control of a shape-memory alloy actuator, and thus more precise and responsive control of an actuated component. In some implementations, switching between the heat mode and cool mode can be controlled by a control module, such as control module 150 shown in FIGS. 6 and 7.

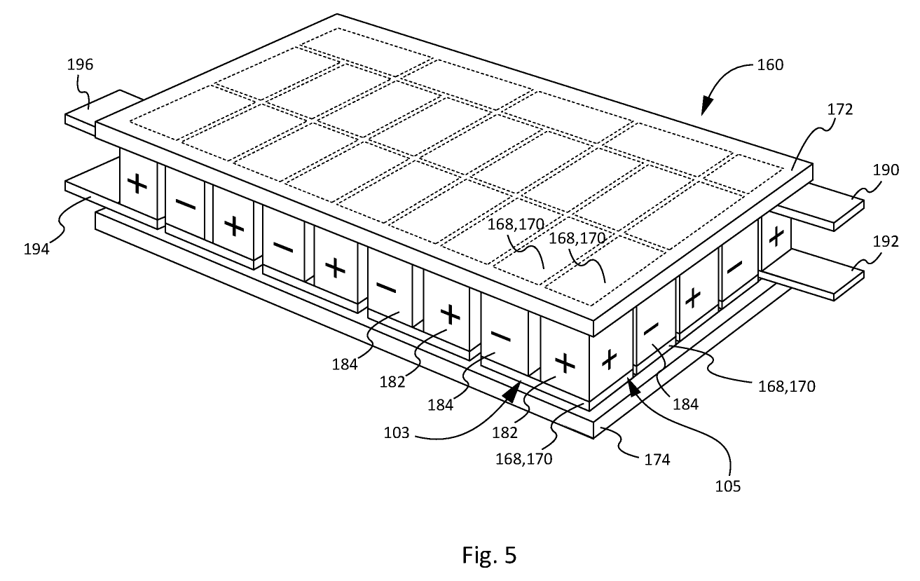

The plurality or array of heaters 102 and coolers 104 of the temperature control system 60 can be arranged relative to each other in any of various patterns or arrays, such as staggered as described above. In certain implementations, the heaters 102 and coolers 104 may be configured and arranged to conserve space and have a higher areal density. For example, as shown in FIG. 5, a temperature control system 160 includes an array of heaters 103 and coolers 105 positioned between outer and inner layers 172, 174. The temperature control system 160 is similar to the temperature control system 60, with like numbers referring to like features. However, unlike the temperature control system 60, each heater 103 of the temperature control system 160 shares its P-element 182 and N-element 184 with adjacent coolers 105, and vice versa. More specifically, each heater 103 includes a P-element 182 and an N-element 184. First ends of the P-element 182 and N-element 184 of each heater 103 are electrically coupled to respective electrical terminals 168 that are electrically insulated from each other. The second ends of the P-element 182 and N-element 184 are electrically coupled together by a bridge electrical terminal 170 that extends between the second ends. This configuration of the heaters 103 is similar to the heaters 102 in that when electrical power is supplied to the heaters 103 in a heat mode via respective positive and negative first power lines 190, 192, heat is transferred from the outer layer 172 (e.g., acting as a cold layer) to the inner layer 174 (e.g., acting as a hot layer).

As shown, each cooler 105 also includes a P-element 182 and an N-element 184. However, the P-element 182 of each cooler 105 is the P-element of the adjacent heater 103. In other words, first adjacent heater 103 and cooler 105 pairs share a P-element 182. Similarly, the N-element 184 of each cooler 105 is the N-element of another adjacent heater 103. In other words, second adjacent heater 103 and cooler 105 pairs share an N-element 184. First ends of the P-element 182 and N-element 184 of the coolers 105 are electrically coupled to respective electrical terminals 168 that are electrically insulated from each other. Moreover, the second ends of the P-element 182 and N-element 184 of each cooler 105 are electrically coupled together by a bridge electrical terminal 170 that extends between the second ends. This configuration of the coolers 105 is similar to the coolers 104 in that when electrical power is supplied to the coolers 105 in a cool mode via respective positive and negative second power lines 194, 196, heat is transferred from the inner layer 174 (e.g., acting as a cold layer) to the outer layer 172 (e.g., acting as a hot layer).

As shown, the electrical terminals 168 of each cooler 105 also function as the bridge electrical terminals 170 for two adjacent heaters 103. Additionally, the bridge electrical terminal 170 for each cooler 105 also functions as one of the two electrical terminals 168 of an adjacent heater 103. Because electrical power is separately and non-concurrently supplied to the heaters 103 and coolers 105 via first power lines 190, 192 and second power lines 194, 196, respectively, and P-elements and N-elements support bi-directional flow of positive and negative elements, the P-elements 182 and N-elements 184 can be shared between adjacent heaters and coolers via the configuration and placement of the electrical terminals 168, 170. Sharing P-elements and N-elements in this manner reduces the number of P-elements and N-elements required to provide the same level of heating and cooler compared to heaters and coolers that do not share P-elements and N-elements.

Although the heaters and coolers of the temperature control system of the present disclosure have heretofore been described as containing one P-element and one N-element, in other embodiments, all or at least one of the heaters and coolers can have more than one P-element and/or N-element. For example, some of all of the heaters and coolers may each have multiple pairs of P-elements and N-elements in certain implementations, and some or all of the heaters and coolers may each have more P-elements than N-elements, or vice versa.

Additionally, in some embodiments, the features of the temperature control system of the present disclosure may incorporate nanoscale or microscale components to conserve space and facilitate microscale thermal management. Similar nanoscale and microscale components may be used to physically and/or electrically couple the temperature control system to other systems of a vehicle or other complex structure.

As shown in the illustrated embodiments, the array of heaters and coolers of the temperature control system are evenly or uniformly distributed between the inner and outer layers such that the heat transfer from the layers is substantially uniform across the layers. However, in some embodiments, it may be desirable to transfer more heat at certain locations relative to the actuator than other locations. Accordingly, the distribution of heaters and coolers may be non-uniform to accommodate any need for more heat transfer at certain locations on the layers compared to other locations. For example, where an actuator demands faster heating and slower cooling at a given location, the portion of the temperature control system adjacent the given location hay have a proportionally larger number of heaters compared to coolers. In contrast, where an actuator demands slower heating and faster cooling at a given location, the portion of the temperature control system adjacent the given location may have a proportionally larger number of coolers compared to heaters. Alternatively, for embodiments where an actuator demands faster heating and cooling at a given location relative to others, the density of heaters and coolers at a portion of the temperature control system adjacent the given location may be higher than other portions of the system.

According to some embodiments, the respective control of the array of heaters and coolers of a temperature control system of the present disclosure may include uniform and/or non-uniform control of the heaters and coolers. In certain implementations, the heaters and coolers are uniformly controlled such that in the heat mode all heaters are activated and controlled to have the same heat transfer characteristics at the same time, and in the cool mode all coolers are activated and controlled to have the same heat transfer characteristics at the same time. In such implementations, the characteristics (e.g., amplitude, frequency, etc.) of the electrical power inputs to each heater or cooler may not be individually controllable.

However, in some implementations, the heaters and coolers can be non-uniformly controlled. For example, in the heat mode, some heaters are selectively activated and other heaters are not, or alternatively, all heaters are activated but controlled differently to produce different heat transfer characteristics at different locations along the temperature control system. Similarly, in the cool mode, some coolers are selectively activated and other coolers are not, or alternatively, all coolers are activated but controlled differently to produce different heat transfer characteristics at different locations along the temperature control system. Additionally, in one embodiment, the temperature control system of the present disclosure may be operable in an intermediate mode where at least some heaters are activated to heat the actuator and at least some coolers are activated to cool the actuator at the same time.

Referring to FIGS. 6 and 7, the uniform and non-uniform control of the heaters and coolers of the temperature control system of the present disclosure can be provided by a control module 150. The control module 150 may execute one or more algorithms that control the heaters and coolers based on inputs from a user (e.g., pilot input, flight control system input, etc.). For example, the input may include a desired configuration of an actuated component (e.g., adjustment of the position of the elevator 20), and the control module 150 in response to the input may activate the heaters and/or coolers to actuate the actuator such the actuated component is placed in the desired configuration.

In some implementations, the control module 150 is operable in a uniform mode to simply close a circuit to supply an electrical current with set characteristics from an electrical power source to all the heaters in the heat mode and all coolers in the cool mode. Alternatively, the control module 150 can be configured to operate in a non-uniform mode in some implementations to selectively close individual circuits to the heaters and coolers to selectively supply an electrical current to each heater and cooler independently of the others. Further, the control module 150 may be configured to regulate the characteristics of the electrical current supplied to the heaters and coolers from the electrical power source whether in a uniform or non-uniform manner. The electrical power source can be a single power source with multiple positive and negative power line sets each corresponding to the heaters and coolers, respectively, of a temperature control system. Alternatively, as shown, the heaters and coolers can be powered by separate electrical power sources (e.g., power sources 120, 130). The electrical power source can be any of various sources known in the art, such as batteries, generators, alternators, and the like.

Shown schematically in FIGS. 6 and 7, the temperature control system 60 may include respective individually-controlled switches or regulators 140 coupled to the electrical power lines 91, 93 of each heater 102 and cooler 104. In one implementation, the switches 140 are individually controllable by the control module 150 to supply or prevent electrical power to respective heaters 102 and coolers 104. Additionally, in some implementations, the switches 140 are individually controllable by the control module 150 to modulate the characteristics of the electrical power supplied to the respective heaters 102 and coolers 104.

According to one embodiment, the control module 150 executes a heat mode by activating the heaters 102 to supply heat 64 to an actuator via a hot inner layer 74. In some implementations, the control module 150 non-uniformly or individually controls each heater 102 by selectively opening or closing the electrical circuits to the heaters via operation of the respective switches 140. For example, if desired, the control module 150 can selectively operate the switches 140 such that only some of the heaters 102 receive an electrical current from the power source 120. Similarly, the control module 150 can execute a cool mode by activating the coolers 104 to transfer heat 64 from an actuator via a cold inner layer 74. In some implementations, the control module 150 non-uniformly or individually controls each cooler 104 by selectively opening or closing the electrical circuits to the coolers via operation of the respective switches 140. For example, if desired, the control module 150 can operate the switches 140 such that only some of the coolers 104 receive an electrical current from the power source 130.

The temperature control system of the present disclosure have any of various shapes, such as round or hollow cylindrical (see, e.g., FIGS. 3 and 4), and flat (see, e.g., FIG. 5). Additionally, the temperature control system can be substantially non-flexible and shaped according to the shape of actuator. Or, alternatively, the temperature control system can be flexible to flexibly conform to the shape of the actuator as the actuator deforms. Further, in some embodiments, temperature control systems can employ a heat sink known in the art to quickly and efficiently dissipate heat.

Although the actuated component has been described in the illustrated embodiments as the elevator 20 of the aircraft 10, the actuated component can be any type of actuated component of any of various types of vehicles or structures. Further, a single vehicle or structure can include multiple actuated components each actuated by a separate shape-memory alloy actuator and associated temperature control system.

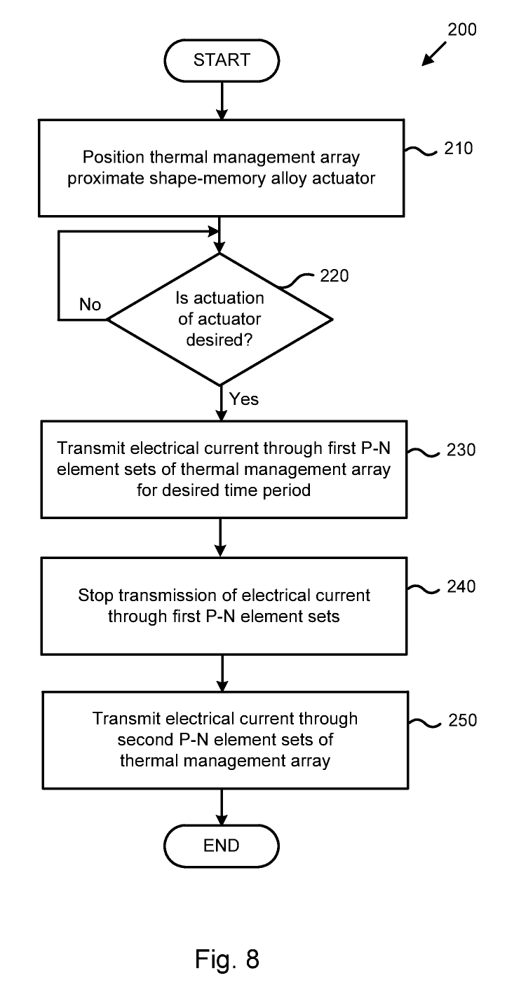

Referring to FIG. 8, one embodiment of a method 200 for controlling actuation of an actuator made from a shape-memory alloy includes positioning a thermal management array of a temperature control system proximate a shape-memory alloy actuator at 210. The thermal management array may include a plurality of heaters 102 and coolers 104 and the temperature control system may be the temperature control system 60 described above. Positioning the thermal management array proximate the shape-memory alloy actuator at 210 can include placing the thermal management array in contact with the actuator or spaced-apart from the actuator. The method 200 includes determining whether actuation of the actuator is desired at 220. If actuation of the actuator is desired, such as via a request to actuate the actuator, then the method 200 transmits an electrical current through first P-N element sets of the thermal management array for a desired time period at 230. Each of the first P-N element sets may include a P-element, such as P-element 82, that is electrically coupleable to an N-element, such as N-element 84. The method 200 may then stop the transmission of electrical current through the first P-N element sets at 240. After step 240, the method 200 proceeds to transmit electrical current through second P-N element sets of the thermal management array at 250. Each of the second P-N element sets may include a P-element, such as P-element 82, that is electrically coupleable to an N-element, such as N-element 84.

In one implementation associated with moderate or cold environments for example, the first P-N element sets form a plurality of thermoelectric heaters such that transmitting electrical current through the first P-N element sets at 230 results in the transfer of heat to and deformation of the shape-memory alloy actuator into a deformed shape to actuate a component. Further, in this implementation, the second P-N element sets can form a plurality of thermoelectric coolers such that transmitting electrical current through the second P-N element sets at 250 results in the transfer of heat away from the shape-memory alloy actuator and a return of the actuator to an original shape and return of the actuated component to an original position.

According to another implementation associated with a heated environment for example, the first P-N element sets form a plurality of thermoelectric coolers such that transmitting electrical current through the first P-N element sets at 230 results in the transfer of heat away from the shape-memory alloy actuator to deform the actuator to actuate a component. Further, in this implementation, the second P-N element sets can form a plurality of thermoelectric heaters such that transmitting electrical current through the second P-N element sets at 250 results in the transfer of heat to the shape-memory alloy actuator to return the actuated component to an original position.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An apparatus for controlling an actuator made from a shape-memory alloy, comprising:
a first layer made from a thermally conductive material;
a second layer made from a thermally conductive material;
at least one thermoelectric heater positioned between the first and second layers; and
at least one thermoelectric cooler positioned between the first and second layers.

2. The apparatus of claim 1, further comprising an electrical power source selectively transmitting electrical power to the thermoelectric heater and thermoelectric cooler.

3. The apparatus of claim 2, wherein electrical power is asynchronously transmitted to the thermoelectric heater and thermoelectric cooler.

4. The apparatus of claim 1, further comprising first electrical connections positioned between the first layer and the thermoelectric heater and cooler, and second electrical connections positioned between the second layer and the thermoelectric heater and cooler, the first and second electrical connections being electrically coupled to an electrical power source.

5. The apparatus of claim 1, wherein each of the thermoelectric heater and cooler comprises a P-element made from a P-type semiconductor material and an N-element made from an N-type semiconductor material.

6. The apparatus of claim 5, wherein the P-element and N-element of the thermoelectric heater and cooler have first and second ends opposing each other, the first ends being proximate the first layer and the second end being proximate the second layer, wherein the first ends of the P-element and N-element of the thermoelectric heater are electrically coupled and the second ends of the P-element and N-element of the thermoelectric heater are electrically isolated from each other, and wherein the first ends of the P-element and N-element of the thermoelectric cooler are electrically isolated from each other and the second ends of the P-element and N-element of the thermoelectric cooler are electrically coupled to each other.

7. The apparatus of claim 6, further comprising a first electrical power source having a negative terminal electrically coupled to the second end of the N-element of the thermoelectric heater and a positive terminal electrically coupled to the second end of the P-element of the thermoelectric heater, and a second electrical power source having a negative terminal electrically coupled to the first end of the N-element of the thermoelectric cooler and a positive terminal electrically coupled to the first end of the P-element of the thermoelectric cooler.

8. The apparatus of claim 1, further comprising a plurality of thermoelectric heaters positioned between the first and second layers, and a plurality of thermoelectric coolers positioned between the first and second layers.

9. The apparatus of claim 8, wherein at least one of the plurality of thermoelectric heaters are evenly distributed between the first and second layers, and the plurality of thermoelectric coolers are evenly distributed between the first and second layers.

10. The apparatus of claim 8, wherein at least one of (i) the plurality of thermoelectric heaters are unevenly distributed between the first and second layers; and (ii) the plurality of thermoelectric coolers are unevenly distributed between the first and second layers.

11. The apparatus of claim 8, wherein each of the plurality of thermoelectric heaters is independently controllable, and each of the plurality of thermoelectric coolers is independently controllable.

12. The apparatus of claim 8, wherein the plurality of thermoelectric heaters and coolers are arranged side-by-side in an alternating pattern.

13. The apparatus of claim 1, further comprising a control module configured to selectively activate the thermoelectric heater to actuate the actuator into an engaged position, and selectively activate the thermoelectric cooler to actuate the actuator into a disengaged position.

14. The apparatus of claim 1, wherein the apparatus is flexible.

15. The apparatus of claim 1, wherein the apparatus has a generally hollow cylindrical shape.

16. An apparatus, comprising:
an adjustable element;
an actuator coupled to the adjustable element, the actuator comprising a shape-memory alloy, wherein modulating a temperature of the shape-memory alloy actuates the actuator; and
a temperature modulation device in heat transfer communication with the actuator, the temperature modulation device comprising an array of p-type semiconductors and n-type semiconductors.

17. The apparatus of claim 16, wherein the temperature modulation device comprises a plurality of heaters and a plurality of coolers, and wherein each heater comprises a pair of p-type and n-type semiconductors in a first orientation and each cooler comprises a pair of p-type and n-type semiconductors in a second orientation.

18. The apparatus of claim 17, wherein the plurality of heaters and plurality of coolers are separately controllable to respectively heat and cool the actuator.

19. The apparatus of claim 17, wherein each of the plurality of heaters is separately controllable relative to other heaters, and each of the plurality of coolers is separately controllable relative to other coolers.

20. The apparatus of claim 16, wherein the apparatus is an aircraft and the adjustable element comprises an aerodynamic surface.

21. A method for controlling actuation of an actuator made from a shape-memory alloy, comprising:
transmitting an electrical current through a first P-N element set to heat the actuator; and
transmitting an electrical current through a second P-N element set to cool the actuator.
